(19) United States
(12) Patent Application Publication
(10) Pub. No.: US 2026/0123672 A1
(43) Pub. Date: May 7, 2026

(54) AEROSOL DELIVERY SUBSYSTEM

(71) Applicant: Nicoventures Trading Limited, London (GB)

(72) Inventors: Ruifan LI, London (GB); Dean COWAN, London (GB); Xiaofeng Xu, London (GB); Hongqiang LIU, London (GB)

(21) Appl. No.: 19/118,731

(22) PCT Filed: Oct. 16, 2023
(86) PCT No.: PCT/GB2023/052682

§ 371 Date: Apr. 4, 2025

(30) Foreign Application Priority Data
Oct. 19, 2022 (CN) 2022112814306
Feb. 3, 2023 (CN) 2023100929534
May 17, 2023 (GB) 2307360.4
May 17, 2023 (GB) 2307362.0

(51) Int. Cl. A24F 40/10; A24F 40/42; A24F 40/46; A24F 40/485; A24F 40/51; A24F 40/70

(52) U.S. Cl. CPC A24F 40/10; A24F 40/42; A24F 40/485; A24F 40/51; A24F 40/70; A24F 40/46

(57) ABSTRACT

An aerosol delivery subsystem comprising a puff sensor at one end, configured to detect air flow through an air inlet in use; and an elongate power supply extending away from the puff sensor and having electrodes at a distal end, away from the puff sensor, for connection to the puff sensor.

### CROSS-REFERENCE TO RELATED APPLICATIONS

This present application is a National Stage entry of PCT Application No. PCT/GB2023/052682, filed Oct. 16, 2023, which claims priority from Great Britian Application No. 2307360.4, filed May 17, 2023, and claims priority from Great Britian Application No. 2307362.0, filed May 17, 2023, and claims priority from Chinese Application No. 2023100929534, filed Feb. 3, 2023, and claims priority from Chinese Application No. 2022112814306, filed Oct. 19, 2022, each of which are fully incorporated herein by reference in their entireties.

### FIELD

The present disclosure relates to aerosol delivery systems such as, but not exclusively, nicotine delivery systems including e-cigarettes, tobacco heated products (THPs) and hybrid systems. More particularly, the present disclosure relates in part to a component mounting bracket for an aerosol delivery subsystem.

### BACKGROUND

Aerosol delivery systems such as electronic cigarettes (e-cigarettes) generally contain an aerosol generating material, such as a chamber of a source solid or liquid, which may contain an active substance and/or a flavour, from which an aerosol or vapour is generated for inhalation by a user, for example through heat vaporisation. Thus, an aerosol delivery system will typically comprise an aerosol generation area containing an aerosol generator, e.g. a heating element, arranged to vaporise or aerosolise a portion of precursor material to generate a vapour or aerosol in the aerosol generation area. As a user inhales on the device and electrical power is supplied to the vaporiser, air is drawn into the device through an inlet hole and along an inlet air channel connecting to the aerosol generation area, where the air mixes with vaporised precursor material to form a condensation aerosol. There is an outlet channel connecting the aerosol generation area to an outlet in the mouthpiece and the air drawn into the aerosol generation area as a user inhales on the mouthpiece continues along the outlet flow path to the mouthpiece outlet, carrying the aerosol with it, for inhalation by the user. Some electronic cigarettes may also include a flavour element in the air flow path through the device to impart additional flavours. Such devices may sometimes be referred to as hybrid devices, and the flavour element may, for example, include a portion of tobacco arranged in the air flow path between the aerosol generation area and the mouthpiece such that aerosol/condensation aerosol drawn through the device passes through the portion of tobacco before exiting the mouthpiece for user inhalation.

It is of interest to develop approaches enabling an aerosol delivery system to be assembled, repaired and/or recycled more readily, to increase production efficiency, improve sustainability and reduce wastage. Various approaches are described herein which seek to help address or mitigate at least some of these issues.

### TERMINOLOGY

### Delivery System

As used herein, the term “delivery system” is intended to encompass systems that deliver at least one substance to a user in use, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

### Combustible Aerosol Provision System

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

### Non-combustible Aerosol Provision System

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

### Aerosol-Free Delivery System

In some embodiments, the delivery system is an aerosol-free delivery system that delivers at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

### Active Substance

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like.

Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco. In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

### Flavours

In some embodiments, the substance to be delivered comprises a flavour. As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

### Aerosol-Generating Material

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

### Aerosol-Former Material

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

### Functional Material

The one or more other functional materials may comprise one or more of pH regulators, colouring agents, preservatives, binders, fillers, stabilizers, and/or antioxidants.

### Substrate

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

### Consumable

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

### Susceptor

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

### Aerosol-Modifying Agent

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent. The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

### Aerosol Generator

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The present disclosure relates to aerosol delivery systems (which may also be referred to as vapour delivery systems) such as nebulisers or e-cigarettes. Throughout the following description the term “e-cigarette” or “electronic cigarette” may sometimes be used, but it will be appreciated this term may be used interchangeably with aerosol delivery system/device and electronic aerosol delivery system/ device. Furthermore, and as is common in the technical field, the terms “aerosol” and “vapour”, and related terms such as “vaporise”, “volatilise” and “aerosolise”, may generally be used interchangeably.

Aerosol delivery systems (e-cigarettes) often, though not always, comprise a modular assembly comprising a reusable device part and a replaceable (disposable/consumable) cartridge part. Often, the replaceable cartridge part will comprise the aerosol generating material and the vaporiser (which may collectively be called a ‘cartomizer’) and the reusable device part will comprise the power supply (e.g. rechargeable power source) and control circuitry. It will be appreciated these different parts may comprise further elements depending on functionality. For example, the reusable device part will often comprise a user interface for receiving user input and displaying operating status characteristics, and the replaceable cartridge device part in some cases comprises a temperature sensor for helping to control temperature. Cartridges are electrically and mechanically coupled to the control unit for use, for example using a screw thread, bayonet, or magnetic coupling with appropriately arranged electrical contacts. When the aerosol generating material in a cartridge is exhausted, or the user wishes to switch to a different cartridge having a different aerosol generating material, the cartridge may be removed from the reusable part and a replacement cartridge attached in its place. Systems and devices conforming to this type of two-part modular configuration may generally be referred to as two-part systems/devices.

It is common for electronic cigarettes to have a generally elongate shape. For the sake of providing a concrete example, certain embodiments of the disclosure will be taken to comprise this kind of generally elongate two-part system employing disposable cartridges. However, it will be appreciated that the underlying principles described herein may equally be adopted for different configurations, for example single-part systems or modular systems comprising more than two parts, refillable devices and single-use disposables, as well as other overall shapes, for example based on so-called box-mod high performance devices that typically have a boxier shape. More generally, it will be appreciated certain embodiments of the disclosure are based on aerosol delivery systems which are operationally configured to provide functionality in accordance with the principles described herein and the constructional aspects of systems configured to provide the functionality in accordance with certain embodiments of the disclosure is not of primary significance.

### BRIEF SUMMARY OF THE INVENTION

The present invention provides aerosol delivery subsystems, systems and methods as claimed.

The claimed invention generally provides a sub-assembly or subsystem 100 suitable for use in an aerosol delivery system 1, or configured for use in an aerosol delivery system 1.

In some embodiments, the subsystem 100 comprises a bracket 110 and may generally form part of an aerosol delivery system 1 and in particular may form part of a reusable device part 2 and/or the consumable cartridge part 4 in a two-part system, or form part of a disposable aerosol delivery system 1. The bracket may include a number of functional features, including but not limited to: integral end cap to seal liquid in the reservoir; retaining part for receiving electrical contact pins; seal between pod/reservoir and battery compartment; supporting battery securely within the housing; and one or more through-holes for airflow.

### BRIEF DESCRIPTION OF THE FIGURES

Embodiments of the disclosure will now be described, by way of example only, with reference to the accompanying drawings, in which:

FIG. 1 is a schematic cross-section view of an aerosol delivery system 1 comprising a bracket 110 in accordance with some embodiments of the disclosure.

FIGS. 2, 3 and 4 are schematic perspective views of an aerosol delivery subsystem 100 in accordance with some embodiments of the disclosure, illustrating the bracket 110 in more detail.

FIG. 5 is a vertical cross-section view of the aerosol delivery subsystem 100 of FIG. 4.

FIG. 6 is a schematic side view of a modular power supply for an aerosol delivery subsystem 100 in accordance with some embodiments of the disclosure.

FIG. 7 is an exploded perspective view of an aerosol delivery system 1 in accordance with some embodiments of the disclosure.

FIG. 8 is a schematic side view of an assembled aerosol delivery system 1 in accordance with some embodiments of the disclosure.

FIG. 9 is a schematic illustration of the assembly process for an aerosol delivery system 1 in accordance with some embodiments of the disclosure.

FIGS. 10, 11, 12 and 13 are schematic perspective views of an aerosol delivery subsystem 100 in accordance with some embodiments of the disclosure, illustrating a second bracket 110.

FIG. 14 is a section view of an aerosol delivery system comprising the second bracket of FIGS. 10-13.

### DETAILED DESCRIPTION OF THE DISCLOSURE

Aspects and features of certain examples and embodiments are described herein. Some aspects and features of certain examples and embodiments may be implemented conventionally and these are not described in detail in the interest of brevity. It will thus be appreciated that aspects and features of apparatuses and methods discussed herein which are not described in detail may be implemented in accordance with any suitable conventional techniques.

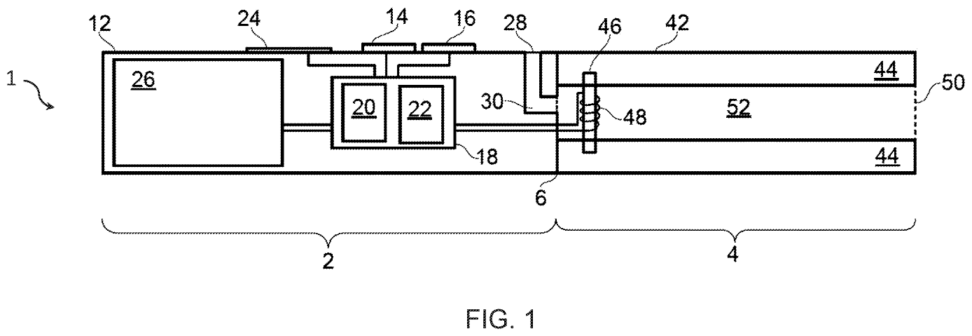

FIG. 1 is a cross-sectional view through an example aerosol delivery system 1 in accordance with certain embodiments of the disclosure, providing an introduction to two-part aerosol delivery systems, the components therein and their functionality. The system 1 comprises a bracket 110 in accordance with some embodiments of the disclosure. The bracket 110 is described in detail later, with reference to the subsequent figures.

The aerosol delivery system 1 comprises two main parts, namely a reusable part 2 and a replaceable /disposable consumable cartridge part 4. In normal use, the reusable part 2 and the cartridge part 4 are releasably coupled together at an interface 6. When the cartridge part 4 is exhausted or the user simply wishes to switch to a different cartridge part 4, the cartridge part 4 may be removed from the reusable part 2 and a replacement cartridge part 4 attached to the reusable part 2 in its place. The interface 6 provides a structural, electrical and airflow path connection between the two parts 2, 4 and may be established in accordance with conventional techniques, for example based around a screw thread, magnetic or bayonet fixing with appropriately arranged electrical contacts and openings for establishing the electrical connection and airflow path between the two parts 2, 4 as appropriate. The specific manner by which the cartridge part 4 mechanically mounts to the reusable part 2 is not significant to the principles described herein, but for the sake of a concrete example is assumed here to comprise a magnetic coupling (not represented in FIG. 1). It will also be appreciated the interface 6 in some implementations may not support an electrical and/or airflow path connection between the respective parts 2, 4. For example, in some implementations an aerosol generator may be provided in the reusable part 2 rather than in the cartridge part 4, or the transfer of electrical power from the reusable part 2 to the cartridge part 4 may be wireless (e.g. based on electromagnetic induction), so that an electrical connection between the reusable part 2 and the cartridge part 4 is not needed.

Furthermore, in some implementations the airflow through the electronic cigarette might not go through the reusable part 2, so that an airflow path connection between the reusable part 2 and the cartridge part 4 is not needed. In some instances, a portion of the airflow path may be defined at the interface between portions of the reusable part 2 and cartridge part 4 when these are coupled together for use.

The cartridge/consumable part 4 may in accordance with certain embodiments of the disclosure be broadly conventional. In FIG. 1, the cartridge part 4 comprises a cartridge housing 42 formed of a plastics material. The cartridge housing 42 supports other components of the cartridge part 4 and provides the mechanical interface 6 with the reusable part 2. The cartridge housing 42 is generally circularly symmetric about a longitudinal axis along which the cartridge part 4 couples to the reusable part 2. In this example, the cartridge part 4 has a length of around 4 cm and a diameter of around 1.5 cm. However, it will be appreciated the specific geometry, and more generally the overall shapes and materials used, may be different in different implementations.

Within the cartridge housing 42 is a chamber or reservoir 44 that contains aerosol-generating material. In the example shown schematically in FIG. 1, the reservoir 44 stores a supply of liquid aerosol generating material. In this example, the liquid reservoir 44 has an annular shape with an outer wall defined by the cartridge housing 42 and an inner wall that defines an airflow path 52 through the cartridge part 4. The reservoir 44 is closed at each end with end walls to contain the aerosol generating material. The reservoir 44 may be formed in accordance with conventional techniques, for example it may comprise a plastics material and be integrally moulded with the cartridge housing 42.

The cartridge/consumable part 4 further comprises an aerosol generator 48 located towards an end of the reservoir 44 opposite to a mouthpiece outlet 50. It will be appreciated that in a two-part system such as shown in FIG. 1, the aerosol generator 48 may be in either of the reusable part 2 or the cartridge part 4. For example, in some embodiments, the aerosol generator 48 (e.g. a heater, which may be in the form of a wick and coil arrangement as shown, a distiller, which may be formed from a sintered metal fibre material or other porous conducting material, or any suitable alternative aerosol generator) may be comprised in the reusable part 2, and is brought into proximity with a portion of aerosol generating material in the cartridge part 4 when the cartridge part 4 is engaged with the reusable part 2. In such embodiments, the cartridge part 4 may comprise a portion of aerosol generating material, and an aerosol generator 48 comprising a heater is at least partially inserted into or at least partially surrounds the portion of aerosol generating material as the cartridge part 4 is engaged with the reusable part 2.

In the example of FIG. 1, a wick 46 in contact with the aerosol generator 48 extends transversely across the cartridge airflow path 52 with its ends extending into the reservoir 44 of the liquid aerosol generating material through openings in the inner wall of the reservoir 44. The openings in the inner wall of the reservoir 44 are sized to broadly match the dimensions of the wick 46 to provide a reasonable seal against leakage from the liquid reservoir 44 into the cartridge airflow path without unduly compressing the wick 46, which may be detrimental to its fluid transfer performance.

The wick 46 and aerosol generator 48 are arranged in the cartridge airflow path 52 such that a region of the cartridge airflow path 52 around the wick 46 and heater 48 in effect defines a vaporisation region for the cartridge part 4. Aerosol generating material in the reservoir 44 infiltrates the wick 46 through the ends of the wick extending into the reservoir 44 and is drawn along the wick by surface tension/capillary action (i.e. wicking). The aerosol generator 48 in this example comprises an electrically resistive wire coiled around the wick 46. In the example of FIG. 1, the heater 48 comprises a nickel chrome alloy (Cr20Ni80) wire and the wick 46 comprises a glass fibre bundle, but it will be appreciated the specific aerosol generator configuration is not significant to the principles described herein. In use, electrical power may be supplied to the aerosol generator 48 to vaporise an amount of aerosol generating material (aerosol generating material) drawn to the vicinity of the aerosol generator 48 by the wick 46. Vaporised aerosol generating material may then become entrained in air drawn along the cartridge airflow path from the vaporisation region towards the mouthpiece outlet 50 for user inhalation.

As noted above, the rate at which aerosol generating material is vaporised by the aerosol generator 48 will depend on the amount (level) of power supplied to the aerosol generator 48. Thus electrical power can be applied to the aerosol generator 48 to selectively generate aerosol from the aerosol generating material in the cartridge part 4, and furthermore, the rate of aerosol generation can be changed by changing the amount of power supplied to the aerosol generator 48, for example through pulse width and/or frequency modulation techniques.

The reusable part 2 comprises an outer housing 12 having with an opening that defines an air inlet 28 for the e-cigarette, a power source 26 (for example a battery) for providing operating power for the electronic cigarette, control circuitry/controller 22 for controlling and monitoring the operation of the electronic cigarette, a first user input button 14, a second user input button 16, and a visual display 24.

The device part 2 also comprises a mounting bracket 110 (not shown in FIG. 1) configured to receive the power source 26, and is described in more detail later, with reference to the subsequent figures.

The outer housing 12 may be formed, for example, from a plastics or metallic material and in this example has a circular cross section generally conforming to the shape and size of the cartridge part 4 so as to provide a smooth transition between the two parts 2, 4 at the interface 6. In this example, the reusable part 2 has a length of around 8 cm so the overall length of the e-cigarette when the cartridge part 4 and the reusable part 2 are coupled together is around 12 cm. However, and as already noted, it will be appreciated that the overall shape and scale of an electronic cigarette implementing an embodiment of the disclosure is not significant to the principles described herein.

The air inlet 28 connects to an airflow path 51 through the reusable part 2. The reusable part airflow path 51 in turn connects to the cartridge airflow path 52 across the interface 6 when the reusable part 2 and cartridge part 4 are connected together. Thus, when a user inhales on the mouthpiece opening 50, air is drawn in through the air inlet 28, along the reusable part airflow path 51, across the interface 6, through the aerosol generation area in the vicinity of the aerosol generator 48 (where vaporised aerosol generating material becomes entrained in the air flow), along the cartridge airflow path 52, and out through the mouthpiece opening 50 for user inhalation.

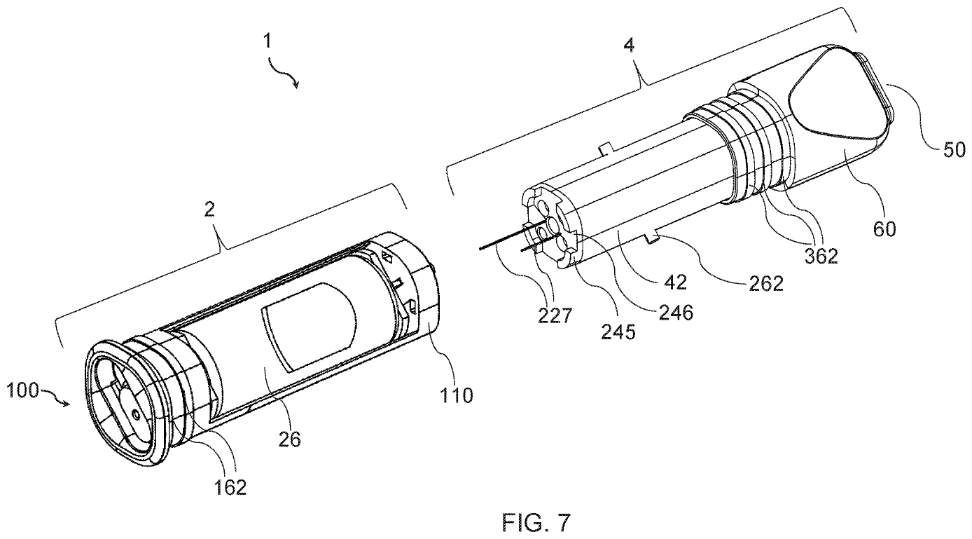

The power source or supply 26 in this example is rechargeable and may be of a conventional type, for example of the kind normally used in electronic cigarettes and other applications requiring provision of relatively high currents over relatively short periods. The power source 26 may be recharged through a charging connector in the reusable part housing 12, for example a USB connector. In embodiments, the power source 26 has a body with a pair of electrodes extending therefrom, for example as illustrated in FIG. 6.

First and/or second user input buttons 14, 16 may be provided, which in this example are conventional mechanical buttons, for example comprising a spring mounted component which may be pressed by a user to establish an electrical contact. In this regard, the input buttons may be considered input devices for detecting user input and the specific manner in which the buttons are implemented is not significant. The buttons may be assigned to functions such as switching the aerosol delivery system 1 on and off, and adjusting user settings such as a power to be supplied from the power source 26 to the aerosol generator 48. However, the inclusion of user input buttons is optional, and in some embodiments buttons may not be included.

A display 24 may be provided to give a user with a visual indication of various characteristics associated with the aerosol delivery system, for example current power setting information, remaining power source power, and so forth. The display may be implemented in various ways. In this example the display 24 comprises a conventional pixilated LCD screen that may be driven to display the desired information in accordance with conventional techniques. In other implementations, the display may comprise one or more discrete indicators, for example LEDs, that are arranged to display the desired information, for example through particular colours and/or flash sequences. More generally, the manner in which the display 24 is provided and information is displayed to a user using the display is not significant to the principles described herein. For example, some embodiments may not include a visual display and/or may include other means for providing a user with information relating to operating characteristics of the aerosol delivery system, for example using audio signalling, or may not include any means for providing a user with information relating to operating characteristics of the aerosol delivery system.

A controller 22 is suitably configured/programmed to control the operation of the aerosol delivery system 1 to provide functionality in accordance with embodiments of the disclosure as described further herein, as well as for providing conventional operating functions of the aerosol delivery system 1 in line with the established techniques for controlling such devices. The controller (processor circuitry) 22 may be considered to logically comprise various sub-units/circuitry elements associated with different aspects of the operation of the aerosol delivery system 1. In this example the controller 22 comprises power supply control circuitry for controlling the supply of power from the power source 26 to the aerosol generator 48 in response to user input, user programming circuitry 20 for establishing configuration settings (e.g. user-defined power settings) in response to user input, as well as other functional units/circuitry associated functionality in accordance with the principles described herein and conventional operating aspects of electronic cigarettes, such as display driving circuitry and user input detection circuitry. It will be appreciated that the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality.

The functionality of the controller 22 is described further herein. For example, the controller 22 may comprise an application specific integrated circuit (ASIC) or microcontroller, for controlling the aerosol delivery device. The microcontroller or ASIC may include a CPU or micro-processor. The operations of a CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required.

The reusable part 2 comprises an airflow sensor 30 which is electrically connected to the controller 22. In most embodiments, the airflow sensor 30 comprises a so-called “puff sensor”, in that the airflow sensor 30 is used to detect when a user is puffing on the device. In some embodiments, the airflow sensor 30 comprises a switch in an electrical path providing electrical power from the power source 26 to the aerosol generator 48. In such embodiments, the airflow sensor 30 generally comprises a pressure sensor configured to close the switch when subjected to a particular range of pressures, enabling current to flow from the power source 26 to the aerosol generator 48 once the pressure in the vicinity of the airflow sensor 30 drops below a threshold value. The threshold value can be set to a value determined by experimentation to correspond to a characteristic value associated with the initiation of a user puff. In other embodiments, the airflow sensor 30 is connected to the controller 22, and the controller distributes electrical power from the power source 26 to the aerosol generator 48 in dependence of a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48 can be carried out in accordance with any approach known to the skilled person.

In the example shown in FIG. 1, the airflow sensor 30 is mounted to a printed circuit board (PCB) 31, but this is not essential. The airflow sensor 30 may comprise any sensor which is configured to determine a characteristic of airflow in an airflow path 51 disposed between air inlet 28 and mouthpiece opening 50, for example a pressure sensor or transducer (for example a membrane or solid-state pressure sensor), a combined temperature and pressure sensor, or a microphone (for example an electret-type microphone), which is sensitive to changes in air pressure, including acoustical signals. The airflow sensor 30 is situated within a sensor cavity or chamber 32, which comprises the interior space defined by one or more chamber walls 34. The sensor cavity 32 comprises a region internal to one or more chamber walls 34 in which an airflow sensor 30 can be fully or partially situated. In some embodiments, the PCB 31 comprises one of the chamber walls of a sensor housing comprising the sensor chamber/cavity 32.

A deformable membrane is disposed across an opening communicating between the sensor cavity 32 containing the sensor 30, and a portion of the airflow path disposed between air inlet 28 and mouthpiece opening 50. The deformable membrane covers the opening, and is attached to one or more of the chamber walls according to approaches described further herein.

As described further herein, the aerosol delivery system 1 comprises communication circuitry configured to enable a connection to be established with one or more further electronic devices (for example, a storage/charging case, and/or a refill/charging dock) to enable data transfer between the aerosol delivery system 1 and further electronic device(s). In some embodiments, the communication circuitry is integrated into controller 22, and in other embodiments it is implemented separately (comprising, for example, separate application-specific integrated circuit(s)/circuitry/ chip(s)/chipset(s)). For example, the communication circuitry may comprise a separate module to the controller 22 which, while connected to controller 22, provides dedicated data transfer functionality for the aerosol delivery device. In some embodiments, the communication circuitry is configured to support communication between the aerosol delivery system 1 and one or more further electronic devices over a wireless interface. The communication circuitry may be configured to support wireless communications between the aerosol delivery system 1 and other electronic devices such as a case, a dock, a computing device such as a smartphone or PC, a base station supporting cellular communications, a relay node providing an onward connection to a base station, a wearable device, or any other portable or fixed device which supports wireless communications.

Wireless communications between the aerosol delivery system 1 and a further electronic device may be configured according to data transfer protocols such as Bluetooth®, ZigBee, WiFi®, Wifi Direct, GSM, 2G, 3G, 4G, 5G, LTE, NFC, RFID, or generally any other wireless, and/or wired, network protocol or interface. The communication circuitry may comprise any suitable interface for wired data connection, such as USB-C, micro-USB or Thunderbolt interfaces, and may comprise pin or contact pad arrangements configured to engage cooperating pins or contact pads on a dock, case, cable, or other external device which can be connected to the aerosol delivery system 1.

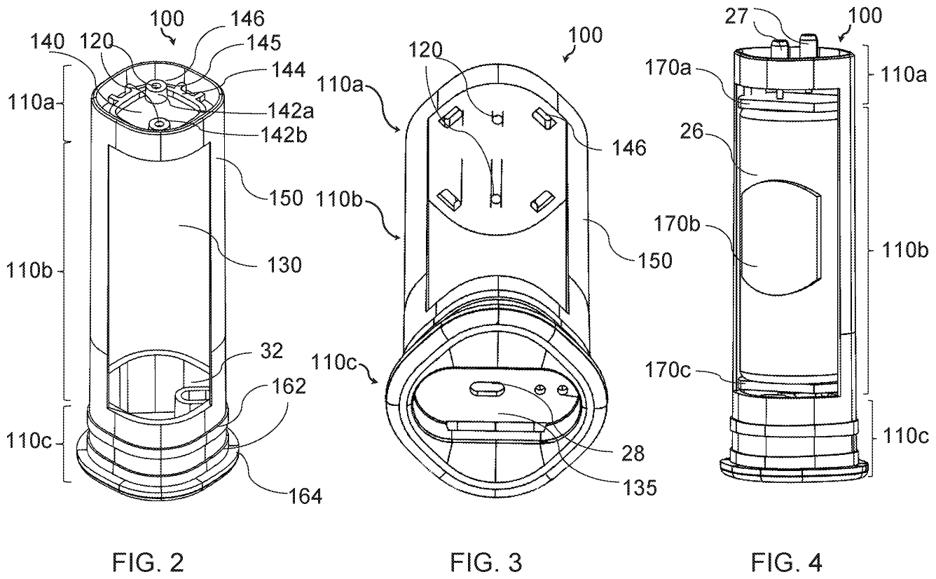

FIGS. 2, 3 and 4 are schematic top-down, bottom-up and side perspective views (respectively) of an aerosol delivery subsystem 100 in accordance with some embodiments of the disclosure, illustrating the bracket 110 in more detail.

As shown in FIGS. 2-4, the bracket 110 is a substantially tubular or cylindrical mounting bracket 110 and is configured to receive a power supply 26, the power supply 26 having a body with a pair of electrodes 27 extending therefrom (shown separately in FIG. 6). The bracket 110 comprises a first (upper) portion 110a having a pair of apertures 120 configured to receive the pair of electrodes 27 and present them for connection at an end of the bracket 110, and a second portion 110b having a cavity 130 configured to receive the power supply body. In the example embodiment of FIGS. 2-4, the pair of apertures 120 extend substantially axially and are configured to receive the pair of electrodes 27 and present them for connection at an axial end of the bracket 110, proximal to the first portion 110a. Further, in the embodiment of FIGS. 2-4, the bracket 110 additionally comprises a third, lower portion 110c having an aperture for providing the air inlet 28 into the subsystem 100, which has a flow path therethrough to deliver the air to the aerosol generator 48 (not shown).

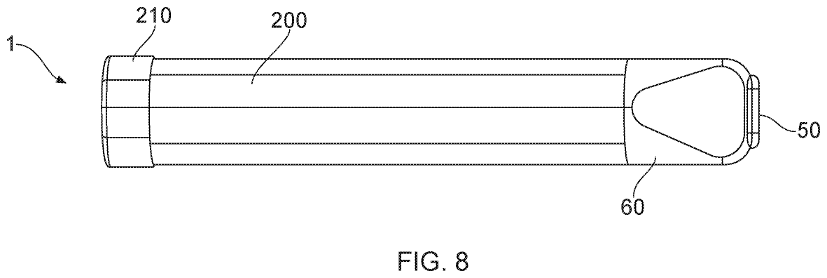

The first (upper) portion 110a generally comprises a truncated tube (or cylinder) having an open upper end for connection to the cartridge part 4 (shown in FIG. 7). The first portion 110a comprises a surface 140 having a platform 142 with the pair of apertures 120 therethrough. In the example embodiment of FIG. 3, the surface 140 is planar and extends substantially radially, and the platform 142 comprises two upright truncated cylinders 142a, 142b, each extending substantially axially (thus substantially perpendicular to the radial surface 140) and each having an aperture 120 therethrough (thereby forming tubes). The platform 142 axially spaces at least a conductive portion of the electrodes 27 from the surface 140 in use. The surface 140 further comprises a circumferential wall 144 and the (walled) surface 140 forms a catchment area for condensate in use. The platform 142 thereby axially spaces at least the conductive portion of the electrodes 27 from the catchment area in use, advantageously minimising the risk of short-circuiting the power supply 26 in use.

The first, second and/or third portions 110a-110c may generally comprise one or more protrusions and/or recesses arranged for receiving, connecting to, interfering or interlocking with an additional component. As shown in FIG. 2, the first portion 110a comprises a plurality of internal protrusions 145 and recesses 146 extending from the wall 144, for engaging or interlocking with complementary protrusions 245 and/or recesses 246 on the cartridge part 4 (as shown in FIG. 7), to secure and/or prevent rotation of the parts 2,4 with respect to one another when joined. In some embodiments, not shown in FIGS. 2-4, an outer side wall 150a of the first portion 110a comprises one or more external protrusions or recesses for engaging with other components, such as an outer shell 200, in use. Such components may optionally comprise complementary protrusions or recesses.

In some embodiments (not shown), any of the portions 110a-110c, but particularly the first (upper) portion 110a, may be asymmetrical in cross-section and/or when viewed from a proximal end, perpendicular to an axial axis of extent thereof. Advantageously, this can provide a one-way fit for the portion to engage with other components (such as the upper portion 110a engaging with the cartridge part 4), which is detectable by a camera to automate assembly, i.e. a camera assembly can uniquely detect the orientation of the first portion 110a and a robotic arm can then position/rotate it as necessary to fit to other components during assembly. The orientation of the first portion 110a may be uniquely identifiable by being asymmetrical in cross-section, particularly with asymmetrical or an otherwise orientation-unique arrangement of the visible features, i.e. the apertures 120, the circumferential wall 144, the platform 142, the surface 140 and/or the protrusions and recesses 145, 146. For example, each of the apertures 120, the platforms 142a, 142b and/or the protrusions and recesses 145, 146 may be of different shapes and/or sizes to one other.

In FIGS. 2-4, the second portion 110b forms an intermediate portion between the first (upper) portion 110a and the third (lower) portion 110c. The second portion 110b generally comprises opposing tubular side walls 150b, which extend around only a partial circumference of the substantially tubular or cylindrical bracket 110, providing the power supply cavity 130 configured to receive the power supply body in use.

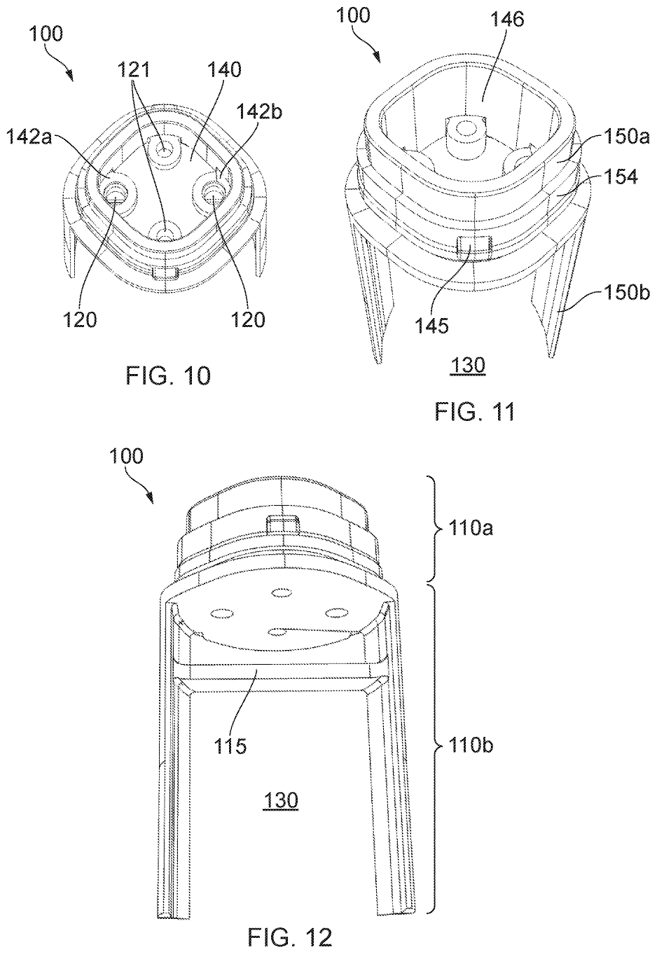

As shown in the example of FIGS. 2-4, the third (lower) portion 110c generally comprises a truncated tube or cylinder having an aperture for providing the air inlet 28 into the subsystem 100. The third portion 110c also comprises an optional sensor cavity 32 for receiving the fluid flow sensor 30, surrounded by a fluid flow sensor seal 33. The third portion 110c additionally comprises a flange 164 for abutting against the outer shell 200 which is received when assembling the system 1 (as shown in FIG. 9), and protrusions in the form of shoulders 162 on an outer wall 150c of the third portion 110c, the shoulder protrusions 162 for engaging with the outer shell 200 and providing an interference fit therewith, securing the outer shell 200 over the subsystem 100. Equally, the other portions 110a, 110b may comprise protrusions, recesses, flanges and/or shoulders for engaging with or abutting against other components such as the outer shell 200.

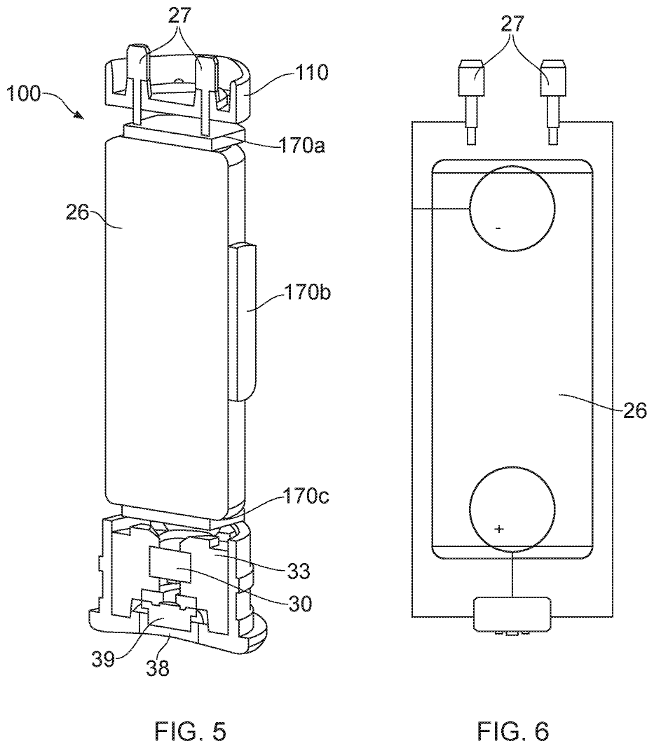

FIG. 3 additionally shows a baffle cavity 135 for receiving a user-operable baffle 138 (not shown, see FIG. 5), which is slidable to adjust the air flow into the device through the inlet 28.

FIG. 4 illustrates the subsystem 100 in use, additionally comprising the power supply 26 and electrodes 27, which extend axially and protrude beyond the axial extent of the first portion 110a, for connection at an axial, proximal end of the bracket 110. The bracket 110 in FIG. 4 also further comprises additional recesses for receiving flexible, resilient and/or absorbent inserts 170a and 170c. In FIG. 4, these comprise two recesses extending radially, one above and one below the power supply cavity 130, for receiving the inserts 170a, 170c above and below the power supply body, respectively. The subsystem 100 also further comprises an insert 170b alongside the power supply body. Since the insert 170b is attached to the power supply body, no recess is necessarily required in the bracket 110, but in further embodiments, the subsystem 100 may comprise a recess extending axially, alongside the power supply cavity 130, for receiving an insert 170b alongside the power supply body. The inserts 170a-170c provide padding between components, to provide solid fitment (e.g. aiding an interference fit), and may be used to reduce/prevent leaks when used with liquid cartridge systems. In some embodiments, the inserts 170a-170c comprise Ethylene-vinyl acetate (EVA).

FIG. 5 is a vertical cross-section view of the aerosol delivery subsystem 100 of FIG. 4. In addition to the features shown in FIG. 4, FIG. 5 shows the optional fluid flow sensor 30 in the air flow path from the air inlet 28, and the fluid flow sensor seal 33 for sealing around the fluid flow sensor 30. In some embodiments, the sensor 30 comprises a microphone or a pressure sensor. FIG. 5 also illustrates the baffle 38 and a baffle seal 39 for sealing around the baffle 38. In some embodiments, the seals 33, 39 comprise silicone.

FIG. 6 is a schematic side view of a modular power supply for an aerosol delivery subsystem 100 in accordance with some embodiments of the disclosure. FIG. 6 illustrates the power supply 26 comprising a body with a pair of electrodes 27 extending therefrom, which are locatable in the pair of apertures 120 for connection to an aerosol generator 48. This arrangement thus provides both an electrical and non-permanent (readily reversible) mechanical connection securing the power supply 26 within the system 1. In some embodiments, not shown in FIG. 6, the electrodes comprising the pair of electrodes 27 are of different shapes and/or sizes to one another, to facilitate assembly, i.e. each electrode can be fitted in only one of the apertures 120.

FIG. 7 is an exploded perspective view of an aerosol delivery system 1 in accordance with some embodiments of the disclosure. As described above, the device part 2 is itself a modular subsystem 100 and comprises the component mounting bracket 110. The cartridge part 4 comprises the cartridge housing 42 which contains aerosol-generating material such as tobacco (for a THP system), or a liquid comprising nicotine (for an e-cigarette) and includes complementary electrically conductive pins 227 for electrically connecting to the electrodes 27 of the power supply 26, to provide power to the aerosol generator 48 therein. The cartridge part 4 also comprises a mouthpiece shell 60 having the mouthpiece outlet 50. As shown in FIG. 9, the mouthpiece shell 60 may be separable from the cartridge housing 42.

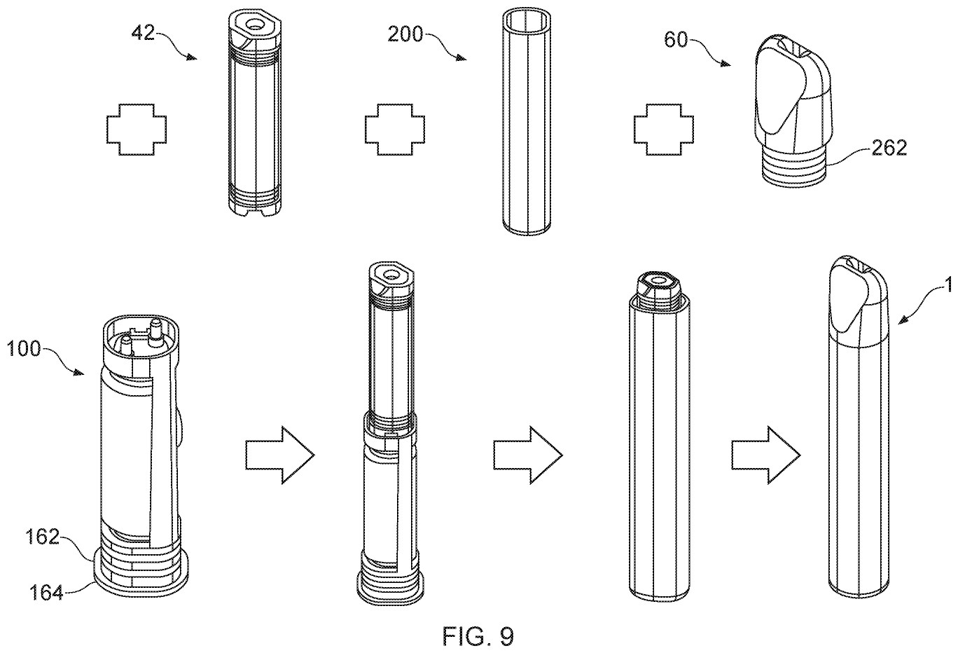

In the example embodiment of FIG. 7, both the device part 2 and the cartridge part 4 are operable to engage an outer shell 200 (shown in FIG. 8) with an interference fit, by both the device part 2 and the cartridge part 4 comprising protrusions 162, 262, 362. Specifically, in this example, the device part 2 comprises protrusions 162 on a distal portion 110c of the bracket 110, whilst the cartridge housing 42 of the cartridge part 4 comprises a protrusion 262 and the mouthpiece shell 60 of the cartridge part 4 comprises protrusions 362. The protrusions 162, 262, 362 extend radially to engage the shell 200 with an interference fit.

As outlined above with reference to FIG. 2, the cartridge part 4 also comprises protrusions 245 and recesses 246 for engaging or interlocking with complementary protrusions 145 and recesses 146 extending from the wall 144 of the first portion 110a, to secure and/or prevent rotation of the parts 2,4 with respect to one another when joined.

FIG. 8 is a schematic side view of an aerosol delivery system 1 in accordance with some embodiments of the disclosure. FIG. 8 illustrates a substantially tubular or cylindrical example of an elongate disposable or reusable e-cigarette or THP system 1, comprising a collar 210 securing the outer shell 200 enclosing the aerosol delivery system 1. In a two-part system such as that of FIG. 7, the outer shell 200 secures over both the device part 2 and the cartridge 4 part. The whole system 1 can thus readily be disassembled, without tools, by removing the push-fit end collar 210 and then extracting the bracket 110 from the shell 200, which removes all of the interconnected subsystem components. The cartridge part 4 can similarly be removed from the other end of the outer shell 200.

FIG. 9 is a schematic illustration of the assembly process for an aerosol delivery system 1 in accordance with some embodiments of the disclosure. The overall system 1 can readily be assembled and disassembled because the subsystem 100 comprises the bracket 110 which houses the components of the device part 2, enabling these to be installed/removed in/from the system 1 collectively. In some embodiments, the various components and/or parts are retained with an interference fit to provide a tool-less assembly.

As shown in FIG. 9, the subsystem 100 receives the cartridge housing 42 at a proximal axial end of the subsystem 100, connecting the electrodes 27 to the aerosol generator 48 within the cartridge housing 42. The outer shell 200 is then secured to the subsystem 100 with an interference fit at the bracket protrusions 162 and pressed axially to abut the bracket flange 164 at the end of the bracket 110. The mouthpiece shell 60 is similarly secured to the outer shell 200 with an interference fit at the mouthpiece shell protrusions 362, thereby securing the outer shell 200 between the bracket flange 164 and the mouthpiece shell 60.

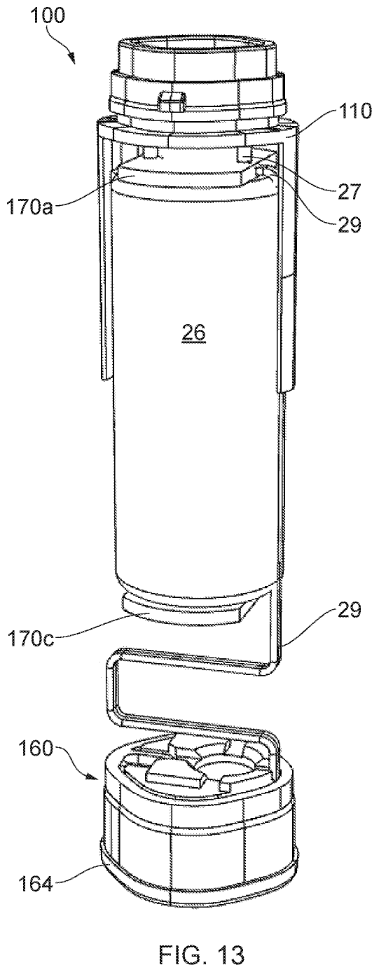

FIGS. 10-14 illustrate a further example of the disclosure which will now be described in more detail. Like reference numerals from the earlier example of FIGS. 1-9 are used for convenience, although any features of the examples may be combined and are specifically contemplated in combination, although detailed discussion of the multiple permutations is omitted for brevity.

FIGS. 10-13 are schematic perspective views of an aerosol delivery subsystem 100 in accordance with some embodiments of the disclosure, particularly illustrating a second bracket 110 in more detail.

In this second example, the bracket 110 comprises a first tubular portion 110a having a pair of apertures 120 configured to receive the pair of power supply terminals/electrodes 27 and present them for connection at an end of the bracket 110, and a second portion 110b comprising tubular side walls 150b which extend around only a partial circumference of the bracket 110 and having a cavity 130 configured to receive the power supply body. The cavity 130 of the second portion 110b is formed by the tubular side walls 150b, which extend axially away from the first portion 110a, best shown in FIG. 12. The apertures 120 extend through a surface spanning side walls of the first portion 110a.

In comparison to the first example, the overall shape of the bracket 110 differs—the second example is generally shaped like a premolar or molar tooth, where the first portion 110a is akin to a crown portion and the second portion 110b akin to roots or legs. This second example also does not require a third portion 110c, nor a circumferential wall 144, although these may still be provided.

The bracket 110 of FIGS. 10-14 comprises one or more apertures 121 configured to provide an air flow path therethrough, which will be described in more detail later.

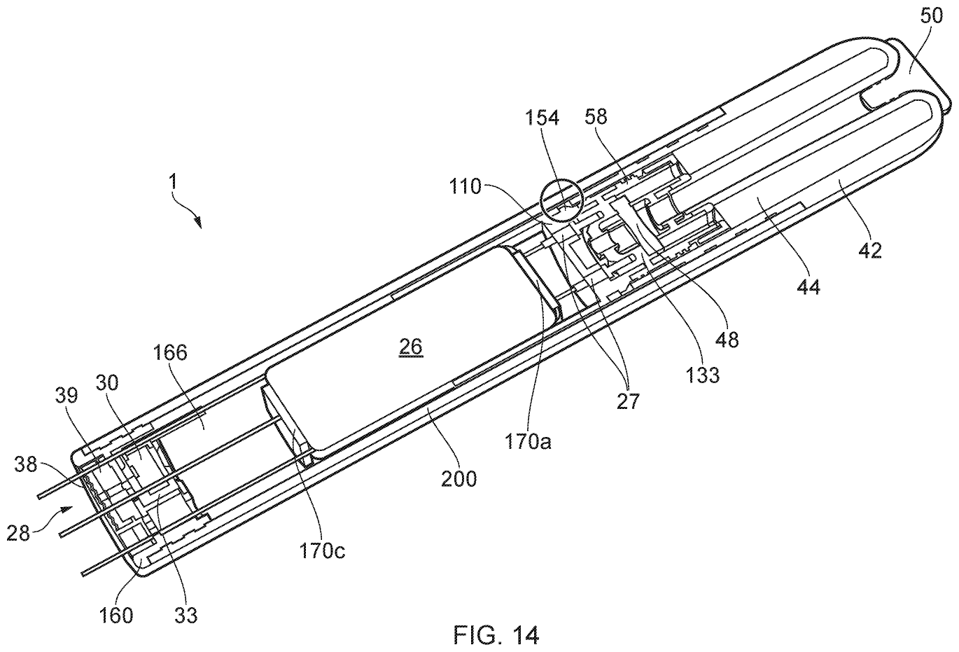

FIG. 11 illustrates the bracket 110 comprising a protrusion in the form of a flange 154 that is configured to receive or engage an aerosol generator 48 or a cartridge/cartomizer. The flange 154 also comprises an external protrusion 145. FIG. 14 illustrates the flange 154 engaging the cartridge housing 42 (circled) in use, described in more detail later.

FIG. 12 illustrates a side view of the bracket 110 and shows that the second portion 110b comprises a bridge support 115 which spaces the end of the power supply body from the first portion 110a and allows air flow through the apertures 121.

FIG. 13 illustrates the subassembly 100 additionally comprising flexible, resilient and/or absorbent inserts 170a and 170c as in the earlier example, and the elongate power supply 26 having wiring 29 extending from the electrodes 27 around the side of the power supply body and down to an end cap 160. In this second example, a separate end cap 160 having flange 164 is provided instead of the bracket 110 comprising a third portion 110c.

In some arrangements, the air flow sensor 30, which is configured to detect air flow through an air inlet 28 in use, is beneficially disposed substantially at one end of the system 1, away from the cartridge and mouthpiece 50, where it is less likely to come into contact with e-liquid or condensate.

In FIGS. 13-14, the end cap 160 comprises the air inlet 28 at a proximal, inlet end of the subsystem (shown in FIG. 14) and the air flow sensor 30 is located in an air flow pathway from the air inlet 28, for detecting puffing, as air flows into the system 1 (shown in FIG. 14). The same benefits arise from the first example shown in FIG. 5, where the third portion 110c of the bracket similarly comprises the air inlet 28 and houses the sensor 30. By contrast, the arrangement of FIG. 1 locates the sensor 30 at the side air inlet 28, which is proximal to the aerosol generator 48, simplifying the air inlet path and power wiring.

In FIG. 13, the sensor 30 is connected to the electrodes of the elongate power supply 26, which extends lengthways away from the sensor 30, by the wiring 29 which runs alongside the battery compartment to the electrodes 27 at a distal/downstream (axial) end of the power supply 26, the electrodes 27 facing/extending away from the sensor 30 (and inlet 28). In FIG. 13, the wiring 29 runs along the right-hand side of the power supply body, between the power supply body and the bracket 110, thus is retained by the bracket 110. Alternatively, the wiring 29 may run alongside the power supply aligned with the midpoint of the electrodes 27, so the wiring 29 can have the same length for both terminals, which are at the furthest axial end of the power supply 26, away from the sensor 30. The bracket 110 may comprise an additional feature such as a third leg to secure the wiring 29. The same terminals/electrodes 27 also provide power to the aerosol generator 48 in use, which is shown in FIG. 14 at a distal/downstream end of the subsystem, further away from the puff sensor 30 and inlet 28. The subsystem might comprise a reusable device portion 2 of an aerosol delivery system 1, for use with a removable/replaceable cartridge part 4.

As best shown in FIG. 13, the wiring 29 is preferably longer than the shortest path from the electrodes 27 to the sensor 30, i.e. has an excess length such that, when connected, the puff sensor 30 is axially separable from the power supply 26, to aid assembly e.g. to allow insertion/removal of the end cap 160 without damaging this connection, permitting this sub-assembly to be assembled outside of the housing/shell 200 before the end cap 160 is pushed into place.

Typically, the power supply 26 may have a length (extending away from the sensor 30) of 25-35 mm, 35-45 mm, or 45-55 mm. Assuming a typical minimum length of 15 mm to connect the sensor 30 to the electrodes/terminals 27 at the distal/downstream axial end of the power supply 26 reliably (noting that the shortest paths might have slightly different lengths for the different +/−terminals), the corresponding minimum wiring length is 40-50 mm, 50-60 mm or 60-70 mm. Preferably, the wiring has an excess length of 20-30 mm, 30-40 mm or 40-50 mm more than this minimum ‘shortest path’ length, to permit easy installation/removal, thus has a length of 60-70 mm, 70-80 mm, 80-90 mm, 90-100 mm, 100-110 mm or 110-120 mm. Any excess length of wiring 29 can be accommodated in a space 166 between the end cap 160 and the power supply 26 (best seen in FIG. 14—the excess length of the wires 29 can be accommodated by coiling in the space 166). The space 166 may also accommodate absorbent material 170c to capture any aerosol-generating material or condensate that might have leaked.

FIG. 14 is a section view of an aerosol delivery system 1 in accordance with some embodiments of the disclosure, comprising the second bracket 110 of FIGS. 10-13. As shown, the aerosol delivery system 1 of FIG. 14 comprises the subsystem of FIG. 13 and additional components forming the system 1.

In addition to the components shown in FIG. 13, the system 1 of FIG. 14 further comprises an outer shell 200 around the end cap 160, bracket 110 and the cartridge housing 42. Internally, the system 1 also comprises a sealing element 133 that engages the first portion 110a of the bracket and an aerosol generator 48, providing a seal therebetween and thus providing a seal between the aerosol generator 48 and the power supply 26 in use. As mentioned above, the flange 154 of the bracket 110 engages the cartridge housing 42 (circled), securing the cartridge to the bracket 110. The bracket 110 provides separation between the cartridge and the power supply 26, reducing the risk of leaks affecting the power supply 26 and sensor 30. The system 1 further comprises a manifold 58 for directing aerosol from the aerosol generator 48 to a mouthpiece 50 at a distal, downstream end of the system 1, opposite to the end cap 160.

As illustrated in FIG. 14, the air inlet 28 to the end cap 160 provides air flow into the system 1 at a proximal, inlet end thereof. The air flow may be adjustable by means of the baffle 38, which is slidable to adjust the air flow into the system 1 through the inlet 28, discussed above with reference to FIG. 5. The system 1 provides an air flow path therethrough, travelling past the power supply 26 and to the aerosol generator 48 to entrain vapour and generate aerosol. In some examples, the bracket 110 provides an air flow path around the power supply 26 e.g. by providing a space between the power supply 26 and the second portion 110b and/or by providing a space between the power supply 26, bracket 110 and inner wall of the shell 200. Such spacing can be provided e.g. by providing a relatively loose fit radially and primarily relying on axial retention, optionally with padding to prevent vibration, or e.g. using an interference fit (e.g. with padding) between the respective elements around only a partial circumference such as in staggered sections. In some examples, the bracket 110 provides an air flow path therethrough from the second portion 110b to the first portion 110a by comprising one or more apertures 121.

As detailed herein, the bracket 110 may thus provide several functions, which may include:
retaining the electrodes/terminals 27 of the power supply 26
presenting or extending the electrodes/terminals 27 of the power supply 26
retaining the power supply 26 itself
securing the cartridge
providing a seal between the cartridge and the power supply 26
providing an air flow path to the aerosol generator/cartridge

Combining several functions into a one-piece component reduces the total component count for the device, helping to reduce cost and simplify the manufacturing/assembly process.

Beneficially, aspects of arrangements disclosed herein (particularly the separation between the cartridge and power supply 26) may allow the cartridge to comprise liquid stored freely in a reservoir, maximising the storage volume without requiring a storage medium such as cotton, which is often used to assist in reducing leaks, but itself occupies volume and absorbs a portion of liquid that cannot be released, thus reducing effective capacity. Using liquid stored freely enables the reservoir to be smaller for the same volume of aerosol-generating material, providing a more compact device. This space saving in the cartridge can provide space to accommodate any excess length of the wires 29 connecting to the air flow sensor 30, avoiding any impact on the overall size of the system 1.

In some examples, as illustrated in FIGS. 1-9, the bracket 110 additionally provides the functionality of the end cap 160.

The modular nature of the overall system 1 and particularly of the subsystem 100 thus allows easy installation and removal of the individual components, such as the power supply body and electrodes 27. In prior arrangements, these connections would typically be soldered and fixed in place within the subsystem 100 directly, one-by-one, and thus be more time-consuming and fiddly to assemble and disassemble, increasing the likelihood of damage when assembling/disassembling. By providing a mounting bracket 110, the various components can be connected together as a modular subsystem 100 which can then be assembled into the whole system 1 collectively, providing a faster, more convenient and less damaging assembly process. Moreover, the process is reversible and thus increases recyclability, which is particularly important for disposable devices which are normally single-use and discard as complete units (and so not recycled). Accordingly, the present invention greatly increases recyclability since the various components can readily be removed and sent to appropriate recycling centres.

Although in the embodiment of FIG. 1, various components (such as the aerosol generator 48) are shown as being a component of the cartridge part 4, in some embodiments these may instead be components of the device part 2 or subsystem 100 and the bracket 110 may comprise additional features such as protrusions, recesses, shelves and/or cavities, for housing these components.

The steps of the disclosed methods may be performed in any suitable order.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention.

Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future. Protection may be sought for any features disclosed in any one or more published documents referenced herein in combination with the present disclosure.

### Particular Features A

1. An aerosol delivery subsystem comprising a substantially tubular or cylindrical mounting bracket, the bracket configured to receive a power supply having a body with a pair of electrodes extending therefrom, the bracket comprising:
   a. a first portion having a pair of apertures configured to receive the pair of electrodes and present them for connection at an end of the bracket; and
   b. a second portion having a cavity configured to receive the power supply body.
2. The subsystem of clause 1, wherein the pair of apertures:
   a. extend substantially axially; and/or
   b. are configured to receive the pair of electrodes and present them for connection at an axial end of the bracket; and/or
   c. are configured to present the pair of electrodes for connection at the end of the bracket proximal to the first portion.
3. The subsystem of any preceding clause, further comprising a third portion having:
   a. an aperture for providing an air inlet into the subsystem; and/or
   b. a cavity for receiving a fluid flow sensor.
4. The subsystem of any preceding clause, wherein the bracket comprises:
   a. a first, upper portion having the pair of apertures configured to receive the pair of electrodes and present them for connection at the end of the bracket;
   b. a second, intermediate portion having the cavity configured to receive the power supply body; and
   c. a third, lower portion.
5. The subsystem of any preceding clause, wherein the first, second and/or third portion comprises:
   a. a truncated cylinder or tube; and/or
   b. opposing side walls which extend around only a partial circumference of the substantially tubular or cylindrical bracket; and/or
   c. a flange or shoulder, for abutting against an outer shell or another component; and/or
   d. protrusions and/or recesses, for engaging with an outer shell or another component.
6. The subsystem of any preceding clause, wherein:
   a. both the first, upper and third, lower portions comprise a truncated cylinder or tube; and
   b. the second, intermediate portion comprises opposing tubular side walls which extend around only a partial circumference of the tube; and
   c. the third, lower portion comprises a flange and protrusions or recesses for removably receiving and engaging an outer shell.
7. The subsystem of any preceding clause, wherein the first portion comprises a surface having a platform with the pair of apertures therethrough, the platform axially spacing at least a conductive portion of the electrodes from the surface in use.
8. The subsystem of clause 7, wherein:
   a. the surface comprises a circumferential wall and forms a catchment area for condensate in use; and
   b. the platform axially spaces at least the conductive portion of the electrodes from the catchment area in use.
9. The subsystem of clause 7 or 8, wherein the surface extends substantially radially and the platform extends substantially axially, substantially perpendicular to the radial surface and away from the catchment area.
10. The subsystem of any preceding clause, wherein the first, second and/or third portion is asymmetrical in cross-section.
11. The subsystem of any preceding clause, wherein the first, second and/or third portion is asymmetrical when viewed from a proximal end, perpendicular to an axial axis of extent thereof.
12. The subsystem of any preceding clause, wherein the first, second and/or third portion comprises a plurality of protrusions and/or recesses arranged for receiving, connecting to, interfering or interlocking with an additional component, wherein the arrangement of the plurality of protrusions and/or recesses is asymmetrical in cross-section.
13. The subsystem of any preceding clause, wherein the apertures of the pair of apertures are of different shapes and/or sizes to one another.
14. The subsystem of any preceding clause, wherein an outer wall of the bracket at one or more ends thereof comprises one or more protrusions or recesses for engaging with complementary protrusions or recesses.
15. The subsystem of any preceding clause, further comprising one or more recesses for receiving a flexible, resilient and/or absorbent insert.
16. The subsystem of any preceding clause, comprising:
   a. a recess extending radially, above and/or below the cavity configured to receive the power supply body, for receiving a flexible, resilient and/or absorbent insert above and/or below the power supply body; and/or
   b. a recess extending axially, alongside the cavity configured to receive the power supply body, for receiving a flexible, resilient and/or absorbent insert alongside the power supply body.
17. The subsystem of any preceding clause, further comprising:
   a. a power supply having a body and electrodes extending therefrom; and/or
   b. a fluid flow sensor; and/or
   c. a seal for sealing around the fluid flow sensor; and/or
   d. a flexible, resilient and/or absorbent insert; and/or
   e. an outer shell for housing the bracket; and/or
   f. a baffle for adjusting air flow through the subsystem; and/or
   g. an aerosol generator; and/or
   h. a cartridge or cartomizer housing an aerosol-generating or smoke-generating material for generating aerosol or smoke for inhalation by a user; and/or
   i. a mouthpiece; and/or
   j. a controller.
18. The subsystem of clause 17, wherein the subsystem is configured to receive the power supply, fluid flow sensor, seal, insert, outer shell, baffle, aerosol generator, cartridge or cartomizer, mouthpiece and/or the controller with an interference fit.
19. The subsystem of clause 17 or 18, comprising the power supply, wherein the pair of electrodes comprise positive and negative electrodes which are of different shapes and/or sizes to one another.
20. A substantially tubular or cylindrical aerosol delivery system comprising the substantially tubular or cylindrical mounting bracket of any preceding clause.
21. A set of instructions for a 3D printer configured to print the aerosol delivery subsystem of any preceding clause.
22. A method of assembling an aerosol delivery subsystem comprising a substantially tubular or cylindrical mounting bracket and a power supply having a body with a pair of electrodes extending therefrom, the method comprising:
   a. mounting the power supply body in a cavity of the bracket; and
   b. mounting the pair of electrodes in a pair of apertures in the bracket, presenting them for connection at an end of the bracket.
23. An aerosol delivery subsystem comprising a substantially tubular or cylindrical mounting means, the mounting means configured to receive a power supply having a body with a pair of electrodes extending therefrom, the bracket comprising:
   a. a first means having a pair of apertures configured to receive the pair of electrodes and present them for connection at an end of the bracket; and
   b. a second means having a cavity configured to receive the power supply body.

### Particular Features B

1. An aerosol delivery subsystem comprising a mounting bracket configured to receive a power supply having a body with a pair of electrodes extending therefrom, the bracket comprising:
   a. a first tubular or cylindrical portion having a pair of apertures configured to receive the pair of electrodes and present them for connection at an end of the bracket; and
   b. a second portion comprising tubular side walls which extend around only a partial circumference of the bracket and having a cavity configured to receive the power supply body.
2. The subsystem of clause 1, wherein the pair of apertures:
   a. extend substantially axially; and/or
   b. extend through a surface spanning side walls of the first tubular or cylindrical portion; and/or
   c. are configured to receive the pair of electrodes and present them for connection at an axial end of the bracket; and/or
   d. are configured to present the pair of electrodes for connection at the end of the bracket proximal to the first portion.
3. The subsystem of any preceding clause, wherein the bracket further comprises one or more apertures configured to provide an air flow path therethrough.
4. The subsystem of any preceding clause, wherein the tubular side walls of the second portion form legs extending axially away from the first portion.
5. The subsystem of any preceding clause, wherein the second portion comprises a bridge support between the tubular side walls.
6. The subsystem of any preceding clause, further comprising a sealing element for sealing between the first portion of the bracket and an aerosol generator or a reservoir, cartridge or cartomizer housing an aerosol-generating or smoke-generating material.
7. The subsystem of any preceding clause, wherein the first portion comprises a flange or protrusion configured to receive or engage an aerosol generator or a reservoir, cartridge or cartomizer housing an aerosol-generating or smoke-generating material.
8. The subsystem of any preceding clause, wherein, in use, when connected to a power supply and an aerosol generator, a reservoir, cartridge or cartomizer, the bracket comprises or provides an air flow path for air flow past the power supply, to the aerosol generator, reservoir, cartridge or cartomizer.
9. The subsystem of any preceding clause, wherein:
   a. the first portion comprises a truncated cylinder or tube; and/or
   b. the second portion comprises opposing side walls which extend around only a partial circumference of the bracket; and/or
   c. the bracket further comprises a flange or shoulder, for abutting against an outer shell or another component; and/or
   d. the bracket further comprises one or more protrusions and/or recesses, for engaging with an outer shell or another component.
10. The subsystem of any preceding clause, wherein the first portion comprises a surface having a platform with the pair of apertures therethrough, the platform axially spacing at least a conductive portion of the electrodes from the surface in use.
11. The subsystem of clause 10, wherein:
   a. the surface comprises a circumferential wall and forms a catchment area for condensate in use; and
   b. the platform axially spaces at least the conductive portion of the electrodes from the catchment area in use.
12. The subsystem of clause 10, wherein the surface extends substantially radially and the platform extends substantially axially, substantially perpendicular to the radial surface and away from the catchment area.
13. The subsystem of any preceding clause, wherein the first and/or second portion is asymmetrical in cross-section.
14. The subsystem of any preceding clause, wherein the first and/or second portion is asymmetrical when viewed from a proximal end, perpendicular to an axial axis of extent thereof.
15. The subsystem of any preceding clause, wherein the first and/or second portion comprises a plurality of protrusions and/or recesses arranged for receiving, connecting to, interfering or interlocking with an additional component, wherein the arrangement of the plurality of protrusions and/or recesses is asymmetrical in cross-section.
16. The subsystem of any preceding clause, wherein the apertures of the pair of apertures are of different shapes and/or sizes to one another.
17. The subsystem of any preceding clause, wherein an outer wall of the bracket at one or more ends thereof comprises one or more protrusions or recesses for engaging with complementary protrusions or recesses.
18. The subsystem of any preceding clause, further comprising one or more recesses for receiving a flexible, resilient and/or absorbent insert.
19. The subsystem of any preceding clause, comprising:
   a. a recess extending radially, above and/or below the cavity configured to receive the power supply body, for receiving a flexible, resilient and/or absorbent insert above and/or below the power supply body; and/or
   b. a recess extending axially, alongside the cavity configured to receive the power supply body, for receiving a flexible, resilient and/or absorbent insert alongside the power supply body.
20. The subsystem of any preceding clause, further comprising:
   a. a power supply having a body and electrodes extending therefrom; and/or
   b. a fluid flow sensor; and/or
   c. a seal for sealing around the fluid flow sensor; and/or
   d. a flexible, resilient and/or absorbent insert; and/or
   e. an outer shell for housing the bracket; and/or
   f. a baffle for adjusting air flow through the subsystem; and/or
   g. an aerosol generator; and/or
   h. a reservoir, cartridge or cartomizer housing an aerosol-generating or smoke-generating material for generating aerosol or smoke for inhalation by a user; and/or
   i. a mouthpiece; and/or
   j. a controller.
21. The subsystem of clause 20, wherein the subsystem is configured to receive the power supply, fluid flow sensor, seal, insert, outer shell, baffle, aerosol generator, reservoir, cartridge or cartomizer, mouthpiece and/or the controller with an interference fit.
22. The subsystem of clause 20 or 21, comprising the sealing element and the aerosol generator, reservoir, cartridge or cartomizer of clause 6.
23. The subsystem of clause 20 or 21, comprising the power supply, wherein:
   a. the pair of electrodes comprise positive and negative electrodes which are of different shapes and/or sizes to one another; and/or
   b. the subsystem comprises an air flow path around the power supply and through one or more apertures in the bracket; and/or
   c. the power supply is retained in the bracket around a partial circumference of the bracket or power supply.
24. The subsystem of clause 20 comprising the reservoir, cartridge or cartomizer, comprising liquid stored freely therein.
25. A set of instructions for a 3D printer configured to print the aerosol delivery subsystem of any preceding clause.
26. An aerosol delivery system comprising the subsystem of any preceding clause.
27. The aerosol delivery system of clause 26, wherein the bracket provides an air flow path around the power supply.

1. An aerosol delivery subsystem comprising:
a. a puff sensor at one end, configured to detect air flow through an air inlet in use; and
b. an elongate power supply extending away from the puff sensor and having electrodes at a distal end, away from the puff sensor, for connection to the puff sensor.

2. The subsystem of claim 1, further comprising wiring for connecting the puff sensor to the distal end electrodes of the power supply, wherein the wiring has excess length such that, when connected, the puff sensor is axially separable from the power supply, to aid assembly.

3. The subsystem of claim 1, wherein the power supply has a length extending away from the puff sensor of 25-35 mm, 35-45 mm, or 45-55 mm.

4. The subsystem of claim 2, wherein the wiring has an excess length of 20-30 mm, 30-40 mm or 40-50 mm.

5. The subsystem of claim wherein the wiring has a length of 60-70 mm, 70-80 mm, 80-90 mm, 90-100 mm, 100-110 mm or 110-120 mm.

6. The subsystem of claim 1, wherein the air inlet is located at the end of the subsystem and the puff sensor is located in an air flow pathway from the air inlet into the subsystem.

7. The subsystem of claim 1, further comprising a mounting bracket for the power supply, the bracket presenting electrodes for connection at an end of the bracket.

8. The subsystem of claim 1, further comprising a baffle across the air inlet, for adjusting air flow through the air inlet.

9. The subsystem of claim 8, wherein the baffle is slidable to adjust the air flow through the air inlet.

10. The subsystem of claim 1, wherein the air inlet is located at a proximal end of the subsystem, the subsystem further comprising an aerosol generator at a distal end of the subsystem, away from the puff sensor.

11. The subsystem of claim 1, wherein the puff sensor, power supply and aerosol generator are substantially axially aligned in the following order: puff sensor-power supply-aerosol generator.

12. The subsystem of claim 1, comprising a cartridge or reservoir housing aerosol-generating material.

13. The subsystem of claim 12, wherein the puff sensor, power supply, aerosol generator and cartridge or reservoir are substantially axially aligned in the following order: puff sensor-power supply-aerosol generator-cartridge or reservoir.

14. The subsystem of claim 12, comprising liquid stored freely in the cartridge or reservoir.

15. The subsystem of claim 1, comprising:
a. a mounting bracket for the power supply;
b. an end cap comprising the puff sensor and the air inlet; and
c. a shell configured to receive the end cap, the mounting bracket and the power supply.

16. The subsystem of claim 15, wherein the shell provides a space for receiving the wiring between the end cap and the power supply.

17. An aerosol delivery system comprising the subsystem of claim 1.

18. The aerosol delivery system of claim 17, comprising a mounting bracket for the power supply, the bracket providing an air flow path around the power supply.

19. The aerosol delivery system of claim 17, comprising a mouthpiece, wherein the puff sensor is located substantially at a proximal end of the system, away from the mouthpiece which is located at an opposite, distal end of the system.

20. A method of assembling an aerosol delivery subsystem, the subsystem comprising:
a puff sensor configured to detect air flow through an air inlet in use;
an elongate power supply extending away from the puff sensor in use and having electrodes at a distal end, away from the puff sensor;
a mounting bracket for the power supply, the bracket presenting electrodes for connection at an end of the bracket; and
wiring for connecting the puff sensor to the electrodes, the wiring passing along a length of the power supply body in use and having excess length to aid assembly, the method comprising:
mounting the power supply in the bracket;
wiring the puff sensor to the electrodes;
mounting the puff sensor in an end cap comprising the air inlet;
locating the bracket and power supply in an outer shell; and
securing the end cap onto the shell to form a proximal end of the system, the shell providing a space between the end cap and the power supply, accommodating the excess length of wiring.
